(19) United States
(12) Patent Application Publication
(10) Pub. No.: US 2026/0058698 A1
(43) Pub. Date: Feb. 26, 2026

(54) CODEBOOK DESIGN EXPLOITING SEPARATE TIME-DOMAIN/DOPPLER-DOMAIN BASIS SELECTION

(71) Applicant: Apple Inc., Cupertino, CA (US)

(72) Inventors: Weidong YANG, San Diego, CA (US); Hong HE, San Jose, CA (US); Seyed Ali Akbar FAKOORIAN, San Diego, CA (US); Huaning NIU, San Jose, CA (US); Wei ZENG, Saratoga, CA (US); Chunxuan YE, San Diego, CA (US); Haitong SUN, Saratoga, CA (US); Sigen YE, San Diego, CA (US)

(21) Appl. No.: 19/103,153

(22) PCT Filed: Aug. 9, 2023
(86) PCT No.: PCT/US2023/071935

§ 371 Date: Feb. 11, 2025

Related U.S. Application Data
(60) Provisional application No. 63/397,651, filed on Aug. 12, 2022.

(51) Int. Cl. H04B 7/0456

(52) U.S. Cl. CPC H04B 7/0456

(57) ABSTRACT

Methods and systems are disclosed to enhance reporting of precoding matrix indication (PMI) associated with fast changing channel response by independently selecting time-domain (TD) or Doppler-domain (DD) basis vectors for different groupings of spatial-domain (SD) and frequency-domain (FD) basis vectors. A UE may generate PMI by applying TD/DD basis vectors in addition to the SD and FD basis vectors to increase the validity time of the PMI. To address the increased signaling overhead associated with the TD/DD components, the UE may group selected spatial beams and FD components to drop inactive spatial beams or inactive FD components based on the LC coefficient matrix. The UE may independently select TD or DD basis vectors for different paired groups of spatial beams and FD components and report the sub-selection of the spatial beams, FD components. and TD or DD component for each group, and the reduced dimension of the LC coefficient matrix.

### RELATED APPLICATIONS

This application claims priority to U.S. Provisional Patent Application 63/397,651, filed on Aug. 12, 2022, the contents of which are hereby incorporated by reference in their entirety.

### FIELD OF INVENTION

This invention relates generally to the field of wireless communication, and more particularly, to systems and methods for reducing the overhead of feeding back precoder information from a highly mobile wireless device to a base station of a wireless communication network when operating in a multiple-input multiple-output (MIMO) configuration. Other aspects are also described.

### BACKGROUND OF THE INVENTION

Wireless communications networks operating in multiple-input multiple-output (MIMO) configurations leverage multiple antenna elements at the transmitter and multiple antenna elements at the receiver to achieve diversity gain, improve beamforming effects, or increase throughput. Precoding operations at the transmitter may be used to improve the performance of MIMO by increasing the orthogonality of the multiple propagation paths from the transmitter to the receiver. Closed loop MIMO involves feedback of precoding matrix information from the receiver to the transmitter based on the receiver's measurements of channel responses to assist the transmitter in configuring precoders. For example, from the feedback information provided by a wireless device (also referred to as user equipment or UE), abase station of the wireless communication network may determine the precoders for multiple occasions of data transmissions from the base station to the wireless device.

Closed loop MIMO provides the base station with increased information but generates an increased signaling overhead. Other challenges of closed loop MIMO may include obsolescence of the feedback information due to channel aging. To enhance the validity of the feedback information, the base station may attempt to trigger frequent feedback reporting, but this further increases the signaling overhead. In addition, due to a minimum time delay between base station reporting triggering and UE reporting of the feedback information, and a minimum time delay between base station allocation of measurements resources and UE reporting, frequent report triggering may still not be enough to handle channel aging. The challenges are further compounded for wireless devices operating in a high-speed environment. As such, it is desired to provide precoding matrix feedback reporting with reduced signaling overhead for receivers in high dynamic channels to enable a predictive model for the channel response and a predictive model for the precoders.

### SUMMARY OF THE DESCRIPTION

Methods and systems are disclosed for a UE to enhance feedback reporting of precoding matrix information when operating in fast-changing channels by exploiting time-domain correlation and Doppler-domain information to assist a base station of a wireless communication network in performing precoding of transmissions from the base station to the UE. Precoder design at the base station and channel response measured at the UE may be implemented as a matrix multiplication of spatial-domain (SD) basis vectors used for SD compression, a linear combination (LC) coefficient matrix, and frequency-domain (FD) basis vectors used for FD compression. Precoders may be configured as the selection of spatial beams (SD basis vectors), selection of FD components (FD basis vectors), and indication of LC coefficients. When the UE travels with medium or high velocities or operating in a fast-changing channel, precoder design may additionally account for the channel response in the time-domain (TD) or Doppler-domain (DD) by selecting TD or DD basis vectors. The generation of the precoders is implemented by applying the SD, FD, and TD/DD basis vectors, which are orthonormal, to the three dimensions. Methods and systems are disclosed for the UE to independently select TD or DD basis vectors for different groupings of SD and FD basis vectors.

A base station of the 4G/5G network may transmit channel state information reference signals (CSI-RS) in a MIMO configuration for a UE to measure the channel response. The UE may report precoding matrix indicator (PMI) based on the measured channel response as part of its CSI reporting to report the preferred precoding for downlink transmission from the base station to the UE. In one aspect, to independently select TD or DD basis vectors for different groupings of SD and FD basis vectors, the grid of SD and FD may be decomposed into orthogonal or non-orthogonal groups. The UE may divide the selected spatial beams into separate groups and divide the selected FD components into separate groups. There may be many zero coefficients in the LC coefficient matrix due to inactive spatial beams or inactive FD components. The inactive spatial beams or inactive FD components may not be selected when constructing the groups of spatial beams or FD components. In one aspect, to reduce the signaling overhead of reporting the PMI from a UE operating in a fast-changing channel, the UE may independently select TD or DD basis vectors for different paired groups of spatial beams and FD components. The TD/DD basis vectors selected for each paired group of spatial beams and FD components may be a sub-selection of the TD/DD components.

In one aspect, the base station to configure the UE with a maximum number of supported groups of the spatial beams and FD components. The UE may report the actually selected groups in consideration of the constraint. The PMI reporting may include any or all of the sub-selection of the spatial beams, the sub-selection of FD components, the sub-selection of TD/DD components for each group, and a LC coefficient matrix for each group. In one aspect, when the number of group is 1, the precoder construction and the PMI reporting reverts back to the case when the TD/DD components are commonly selected for all spatial beams and FD components. In one aspect, the LC coefficient matrix may have a reduced dimension due to the sub-selection of the spatial beams, FD components, and TD/DD components. In one aspect, a bitmap matrix may be used to indicate positions of non-zero coefficients in the LC coefficient matrix for each group.

In one aspect, the independent selection of the TD/DD basis vectors for different paired groups of spatial beams and FD components may be indicated as a selection of the TD/DD components in a two-dimensional grid. In one aspect, one dimension of the grid may represent a product of the number of spatial beams and the number of FD components, and the other dimension may represent the number of TD components. For each group, the signaling of selected spatial beam/FD component pair (or pairs) is indicated, and the signaling of the selected TD components for that group is indicated. In one aspect, one dimension of the grid may represent a product of the number of FD components and the number of TD components, and the other dimension may represent the number of spatial beams. For each group, the signaling of selected FD component/FD component pair (or pairs) is indicated, and signaling of the selected spatial beams for that group is indicated. There may be a LC coefficient matrix for each group, for which a bitmap matrix may be used to indicate positions of non-zero coefficients in the LC coefficient matrix.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one aspect of the disclosure.

FIG. 2 illustrates user equipment in direct communication with a base station (BS) according to one aspect of the disclosure.

FIG. 3 illustrates an example block diagram of a UE according to one aspect of the disclosure.

FIG. 4 illustrates an example block diagram of a BS according to one aspect of the disclosure.

FIG. 5 illustrates an example block diagram of cellular communication circuitry according to one aspect of the disclosure.

FIG. 6 illustrates a construction of precoders over the 3-dimension of spatial, frequency, and time domains using 3 orthonormal basis vectors of the SD, FD, and TD, according to one aspect of the disclosure.

FIG. 7 illustrates a representation of the precoding matrices according to 5G Type II codebook at various times in the time domain using a matrix SD basis vectors, a matrix of FD basis vectors, and a matrix of TD basis vectors, according to one aspect of the disclosure.

FIG. 8 illustrates a decomposition of the spatial-domain and frequency-domain space into orthogonal groups of spatial beams and FD components for independent selection of TD or DD basis vectors for different groups of SD and FD basis vectors, according to one aspect of the disclosure.

FIG. 9 illustrates a decomposition of the spatial-domain and frequency-domain space into non-orthogonal groups of spatial beams and FD components for independent selection of TD or DD basis vectors for different groups of SD and FD basis vectors, according to one aspect of the disclosure.

FIG. 10 illustrates a decomposition of the spatial-domain and frequency-domain space into non-orthogonal groups of spatial beams and FD components for independent selection of TD or DD basis vectors for different groups of SD and FD basis vectors where each group may contain non-rectangular or non-contiguous selection of the spatial beams and FD components, according to one aspect of the disclosure.

FIG. 11 illustrates a selection of TD components for different orthogonal groups of SD and FD basis vectors represented by a two-dimensional LC coefficient matrix grid, where one dimension of the grid may represent a product of the number of spatial beams and the number of FD components, and the other dimension may represent the number of TD components, according to one aspect of the disclosure.

FIG. 12 illustrates a selection of TD components for different non-orthogonal groups of SD and FD basis vectors represented by a two-dimensional LC coefficient matrix grid, where one dimension of the grid may represent a product of the number of spatial beams and the number of FD components, and the other dimension may represent the number of TD components, according to one aspect of the disclosure.

FIG. 13 illustrates a selection of TD components for different orthogonal groups of SD and FD basis vectors represented by a two-dimensional grid, where one dimension of the grid may represent a product of the number of FD components and the number of TD components, and the other dimension may represent the number of spatial beams, according to one aspect of the disclosure.

FIG. 14 illustrates a selection of TD components for different non-orthogonal groups of SD and FD basis vectors represented by a two-dimensional grid, where one dimension of the grid may represent a product of the number of FD components and the number of TD components, and the other dimension may represent the number of spatial beams, according to one aspect of the disclosure.

FIG. 15 depicts a flow diagram of a method for a UE to independently select TD or DD basis vectors for different groupings of SD and FD basis vectors and to report the sub-selection of the spatial beams, the sub-selection of FD components, the sub-selection of TD/DD components for each group according to one aspect of the disclosure.

### DETAILED DESCRIPTION

Methods and systems are disclosed to enhance reporting of precoding matrix information associated with fast changing channel response by independently selecting time-domain (TD) or Doppler-domain (DD) basis vectors for different groupings of spatial-domain (SD) and frequency-domain (FD) basis vectors. A UE experiencing fast changing channel response such as in high mobility, high velocity, or high Doppler scenarios may generate precoding matrix indication (PMI) by applying TD/DD basis vectors in addition to the SD and FD basis vectors to increase the validity time of the PMI. To address the increased signaling overhead associated with the additional third dimension of the TD/DD components, the UE may group selected spatial beams and FD components to drop inactive spatial beams or inactive FD components based on the LC coefficient matrix. The UE may independently select TD or DD basis vectors for different paired groups of spatial beams and FD components. The UE may report the spatial beam sub-selection, FD component sub-selection and TD or DD component sub-selection for each group, and the reduced dimension of the LC coefficient matrix as part of the PMI. For each LC coefficient matrix of reduced dimension, there may be a bitmap matrix of the same dimension as the LC coefficient matrix, and “1”s are used to indicate positions of non-zero coefficients in the LC coefficient matrix.

In one aspect, a method for reporting precoding matrix information may include a UE receiving from a base station of a communication network configuration information for grouping SD and FD basis vectors used to construct precoders for MIMO operations. The UE may measure downlink reference signals transmitted by the base station to generate measurements of downlink channels. The UE may determine, constrained by the configuration information, subset groupings of the SD basis vectors (spatial beams) and the FD basis vectors based on the measurements of the downlink channels. The UE may select TD or DD basis vectors for the subset groupings of the SD and FD basis vectors. The UE may transmit to the base station precoder information for downlink transmission based on the subset groupings of the SD and FD basis vectors, and the selected TD or DD basis vectors for the subset groupings.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

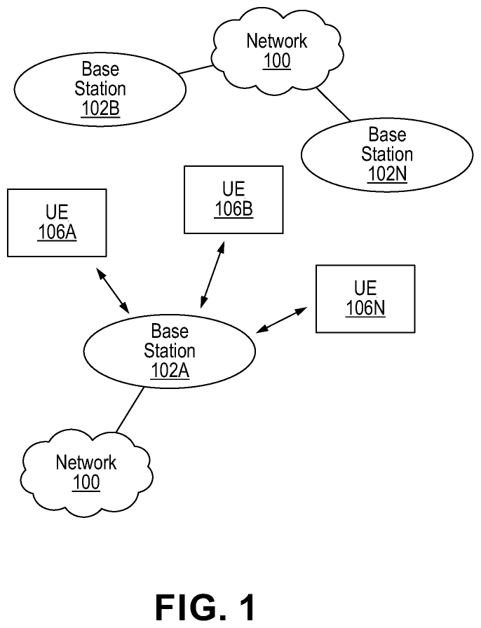

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

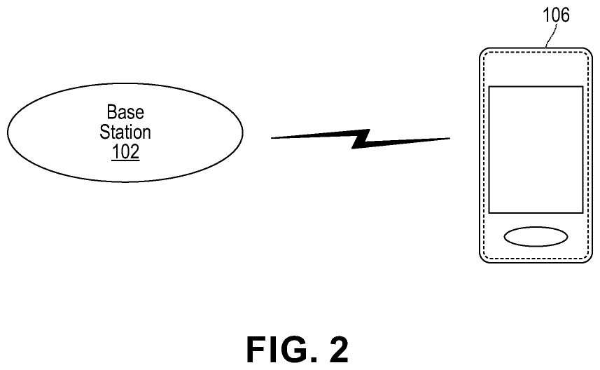

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

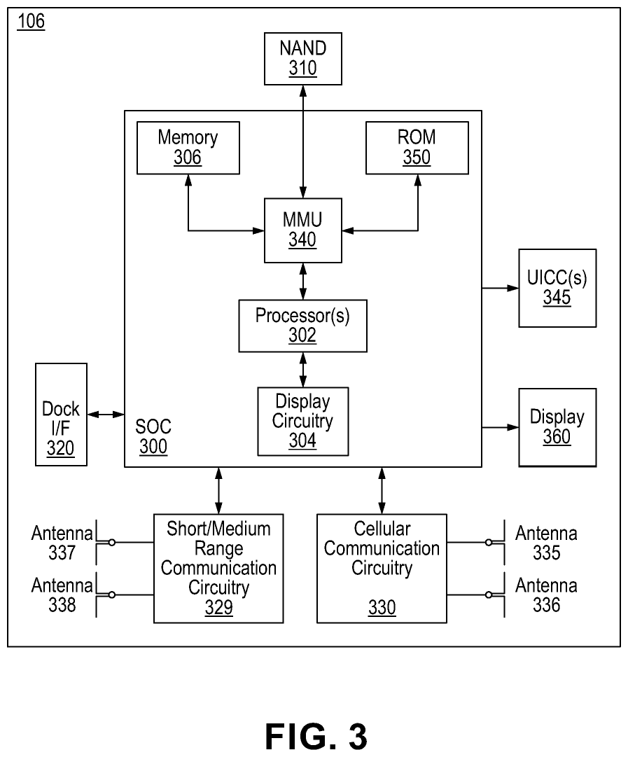

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

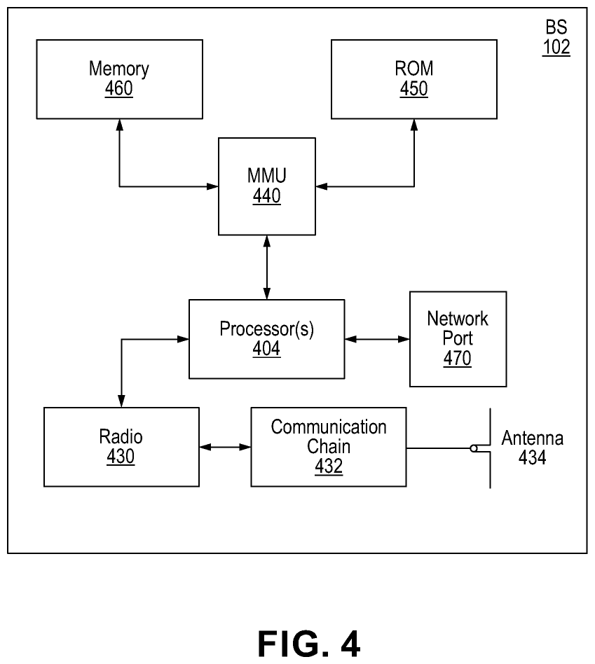

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

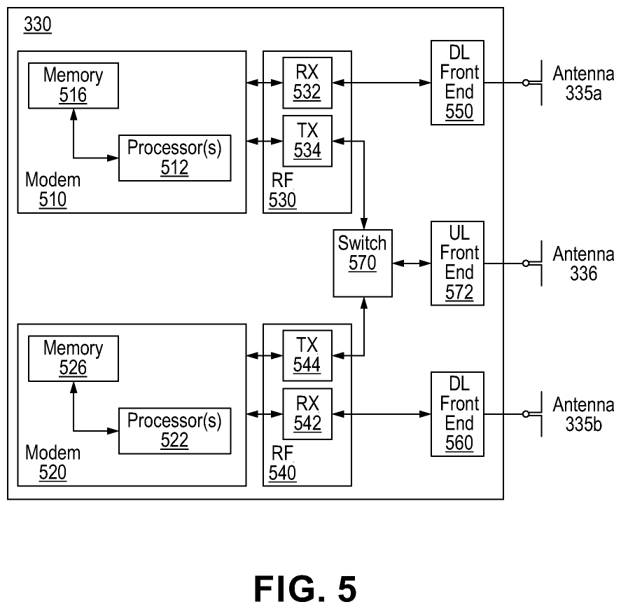

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

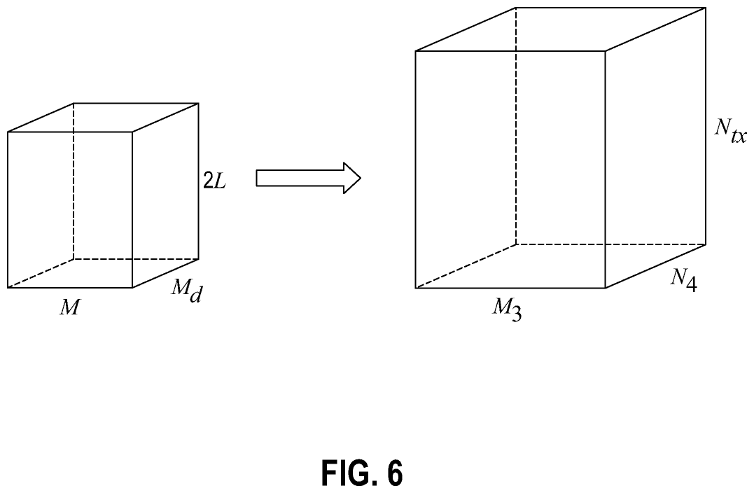

FIG. 6 illustrates a construction of precoders over the 3-dimension of spatial, frequency, and time domains using 3 orthonormal basis vectors of the SD, FD, and TD, according to one aspect of the disclosure.

From the 3D kernel shown on the left, precoders over N₃ sub-bands, N₄ time occasions, and Nₜₓ spatial beams may be constructed by applying 3 orthonormal basis vectors in the frequency-domain, time-domain, and spatial-domain. The 3 orthonormal basis vectors in the FD, TD, and SD may be represented by FD basis matrix W_{f}, TD basis matrix Wₜ (may also be denoted as Doppler-domain (DD) basis matrix W_{d} due to the duality between TD and DD), and SD basis matrix W₁, respectively. Compression in the FD, TD, and SD using their respective basis vectors may reduce the FD basis matrix W_{f} to M size-N₃×1 orthogonal DFT vectors (W_{f} ∈C^{N}^{₃}^{×M}), reduce the TD basis matrix Wₜ to M_{d} size-N₄×1 orthogonal DFT vectors (Wₜ ∈C^{N}^{₄}^{×M}^{_{d}}), and reduce the SD basis matrix W₁ to 2L size-Nₜₓ×1 orthogonal DFT vectors (W₁ ∈C^{N}^{ₜₓ}^{×2L}), (the 2L accounting for L SD basis vectors in each of two polarizations of an antenna array). The compression in the TD may take advantage of the TD correlation properties.

The Kronecker product may be used to get a convenient representation for some matrix equations. Consider for instance the equation AXB=C, where A, B and C are given matrices and the matrix X is the unknown. The “vectorization trick” may be used to rewrite this equation as

$$( {B}^{T} ⊗ A ) vec ( X ) = vec ( AXB ) = v e c ( C )$$

Here, vec(X) denotes the vectorization of the matrix X, formed by stacking the columns of X into a single column vector. It follows from the properties of the Kronecker product that the equation AXB=C has a unique solution, if and only if A and B are invertible. If X and C are row-ordered into the column vectors u and v, respectively, then

$$v = ( A ⊗ {B}^{T} ) u .$$

The reason is that

$$v = v e c ( {( A X B )}^{T} ) = v e c ( {B}^{T} {X}^{T} {A}^{T} ) = ( A ⊗ {B}^{T} ) v e c ( {X}^{T} ) = ( A ⊗ {B}^{T} ) u .$$

The precoding matrix according 5G Type II codebook at time instance t may be represented by

$${W}^{( t )} = {W}_{1} {\tilde{W}}_{2}^{( t )} {W}_{f}^{H}$$

As discussed previously, W₁∈C^{N}^{ₜₓ}^{×2L} is an SD basis matrix and W_{f}∈C^{N}^{₃}^{×M} is an FD basis matrix.

$${\tilde{W}}_{2}^{( r )} ∈ {C}^{2 L \times M}$$

is a linear combination coefficient matrix, W^{(t)}=C^{N}^{ₜₓ}^{×N}^{₃}. Then applying the vectorization operation, the precoding matrix may be represented as:

$$v ec ( {W}^{( t )} ) = ( {W}_{f}^{*} ⊗ {W}_{1} ) v e c ( {\tilde{W}}_{2}^{( t )} )$$

Here

$$vec ( {W}^{( r )} ) ∈ {C}^{{N}_{tx} {N}_{3} \times 1} , vec ( {\tilde{W}}_{2}^{( r )} ) ∈ {C}^{2 LM \times 1} , ( {W}_{f}^{*} ⊗ {W}_{1} ) ∈ {C}^{{N}_{tx} {N}_{3} \times 2 LM} .$$

The precoding matrices at time instances (tₙ, tₙ+dₜ, tₙ+2dₜ, . . . , tₙ+(N₄−1)dₜ) may then be represented by:

$$\begin{matrix}W = [ vec ( {W}^{( {t}_{n} )} ) , vec ( {W}^{( {t}_{n} + {d}_{t} )} ) , vec ( {W}^{( {t}_{n} + 2 {d}_{t} )} ) , … , vec ( {W}^{( {t}_{n} + ( {N}_{4} - 1 ) {d}_{t}} ) ] \\ = ( {W}_{f}^{*} ⊗ {W}_{1} ) [ vec ( {\tilde{W}}_{2}^{( {t}_{n} )} ) , vec ( {\tilde{W}}_{2}^{( {t}_{n} + {d}_{t} )} ) , vec ( {\tilde{W}}_{2}^{( {t}_{n} + 2 {d}_{t} )} ) , … , vec ( {\tilde{W}}_{2}^{( {t}_{n} + ( {N}_{4} - 1 ) {d}_{t} )} ) ]\end{matrix}$$

### Let

$${\tilde{W}}_{2} = [ vec ( {\tilde{W}}_{2}^{( {t}_{n} )} ) , vec ( {\tilde{W}}_{2}^{( {t}_{n} + {d}_{t} )} ) , vec ( {\tilde{W}}_{2}^{( {t}_{2} + 2 {d}_{t} )} ) , … , vec ( {\tilde{W}}_{2}^{( {t}_{n} + ( {N}_{4} - 1 ) {d}_{t}} ) ] ,$$

\tilde{W}₂ may be compressed due to the correlation in the time domain:

$${\tilde{W}}_{2} = {W}_{2} {W}_{t}^{H}$$

Here W₂ ∈C^{2LM×M}^{_{d}} is a linear combination coefficient matrix with compression in the time domain. The feedback overhead of the coefficients is then reduced from 2LM×N₄ to 2LM×M_{d} with the time domain compression.

Wₜ ∈C^{N}^{₄}^{×M}^{_{d}} is a basis matrix in the time domain that is selected from C^{N}^{₄}^{×QN}^{₄} DFT vectors:

$$\begin{matrix}{W}_{t} = [ {f}_{t , 0} , {f}_{t , 1} , … , {f}_{t , {M}_{d} - 1} ] , {f}_{t , v} = {[ 1 , {e}^{j 2 π {k}_{v} \frac{1}{{QN}_{4}}} , … , {e}^{j 2 π {k}_{v} \frac{n}{{QN}_{4}}} , … , {e}^{j 2 π {k}_{v} \frac{{N}_{4} - 1}{{QN}_{4}}} ]}^{T} \\ ∈ {C}^{{N}_{4} \times 1}\end{matrix}$$

Here Q is an oversampling factor.

Then the precoding matrices W may then be expressed as:

$$W = ( {W}_{f}^{*} ⊗ {W}_{1} ) {W}_{2} {W}_{t}^{H}$$

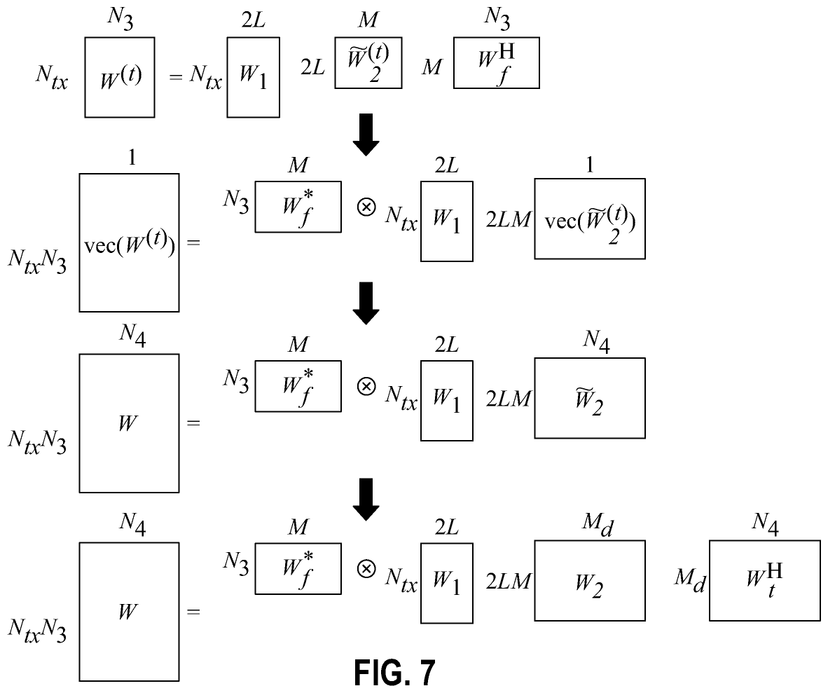

FIG. 7 illustrates a representation of the precoding matrices W according to 5G Type II codebook using the SD basis matrix W₁, the FD basis matrix W_{f}, and the TD basis matrix Wₜ as derived above using the vectorization operation and the compression in the time domain, according to one aspect of the disclosure. As some elements or coefficients in the matrix W₂ may be zero, a bitmap matrix of the same dimensions (Z) as W₂ can be used to indicate positions of non-zero elements in the matrix W₂. However, the signaling overhead of Z is M·(2L)·M_{d} bits, which can be large.

The derivation of the precoding matrices W illustrated in FIG. 7 is equivalent to applying the expansion to the spatial domain and FD domain first:

$$\begin{matrix}{W}_{1} C ( : , : , t ) {W}_{f}^{H} \\ t = 1 , … , {M}_{d} .\end{matrix}$$

Applying the vectorization reformulation, then

$$vec ( {W}_{1} C ( : , : , t ) {W}_{f}^{H} ) = ( {W}_{f}^{*} ⊗ {W}_{1} ) vec ( C ( : , : , t ) )$$

Expanding in the TD domain, N₄ precoders, each of them at N_tx·N_3×1, are given by

$$[ vec ( C ( : , : , 1 ) ) , … , vec ( C ( : , : , {M}_{d} ) ) ] {W}_{t}^{H}$$

As noted, the signaling overhead of Z used to indicate positions of non-zero elements in the LC coefficient matrix W₂ can be large. However, W₂ may be rather sparse or exhibit patterns due to the limited number of clusters and their corresponding Doppler shifts. In this case, constructing the precoding codeword as a summation over multiple groups of triplets consisting of selected spatial beams, selected FD components, and TD components corresponding to the selected SD/FD basis vectors may lead to a lower feedback overhead. In one aspect, the TD basis vectors or the DD basis vectors may be independently selected for different SD/FD basis vectors. In one aspect, the whole grids of spatial domain/FD domain (2L×M), is decomposed into orthogonal groups. For example, the selected spatial beams may be divided into Nₛ groups, G_{s,i}, 1≤i≤Nₛ, Nₛ≥1 (e.g. L=4, Nₛ=2, {G_{s,1}=[1358], G_{s,2}=[2467]}), and the selected FD components may be divided into N_{FD} groups, 1≤j≤N_{FD}, N_{FD}≥1 (e.g. M=6 N_{FD}=2, then {G_{FD,1}=[a, b, e, f], G_{FD,2}=[c, d]}). Then the decomposition may be represented by:

$$\{ {G}_{s , 1} , … , {G}_{S , {N}_{s}} \} \times \{ {G}_{FD , 1} , … , {G}_{FD , {N}_{FD}} \}$$

The grouping or sub-selection can be uniform such the number of elements in each set is the same, or non-uniform so the number of elements in a set can be different from that for another set. The grouping or sub-selection may be over contiguous indices with or without wrap-around, or the grouping may be over non-contiguous indices.

If backward compatibility is considered, so spatial beam selection from both polarizations is always conducted, and the prescribed number of selected FD components is always taken, then there may be many zero linear combination coefficients due to inactive spatial beams (a spatial beam s is designated inactive if all the C(s, :, :) coefficients are zero) or inactive FD components (an FD component f is designated inactive if all the C(:, f, :) coefficients are zero), then the cardinality of

$${⋃}_{i = 1}^{{N}_{s}} {G}_{S , i}$$

may be less than 2L. Similarly, the cardinality of

$${⋃}_{i = 1}^{{N}_{FD}} {G}_{FD , i}$$

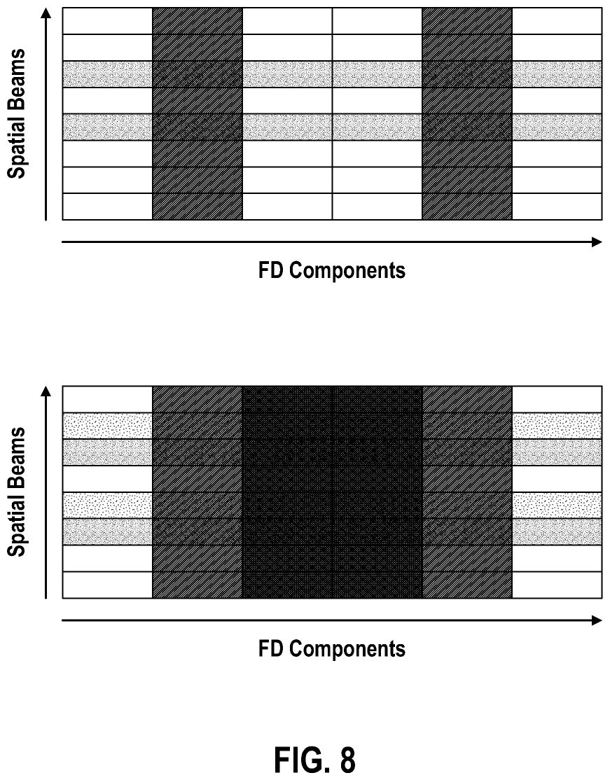

may be less than M as shown in FIG. 8

FIG. 8 illustrates a decomposition of the spatial-domain and frequency-domain space into orthogonal groups of spatial beams and FD components for independent selection of TD or DD basis vectors for different groups of SD and FD basis vectors, according to one aspect of the disclosure. The groups of spatial beams and FD components are orthogonal because a selected spatial beam extends across all the FD components and a selected FD component extends across all the spatial beams.

Then over a pair (G_{s,i}, G_{FD,j}), separate selection of time-domain basis vectors or Doppler-domain basis vectors may be selected. Note this is for overhead reduction. If such independent selection is not allowed, then the feedback overhead is controlled by all the TD or DD components. The top grid of FIG. 8 shows 2 groups of SD basis vectors, G_{s,1}, G_{s,2} and 2 groups of FD basis vectors G_{FD,1}, G_{FD,2}. There may then be 4 groups of pairing of SD basis vectors and FD basis vectors: (G_{s,1}, G_{FD,1}), (G_{s,1}, G_{FD,2}), (G_{s,2}, G_{FD,1}), (G_{s,2}, G_{FD,2}), each of the 4 groups with its separate selections of TD or DD basis vectors. The bottom grid of FIG. 8 also shows 2 groups of SD basis vectors and 2 groups of FD basis vectors, with each group SD basis vectors or FD basis vectors comprising either 2 contiguous or 2 non-contiguous selection of spatial beams or FD components.

In one aspect, non-orthogonal decomposition may also be supported.

$${⋃}_{p = 1}^{P} {G}_{s , p} \times {G}_{FD , p} ,$$

so for each pair (G_{s,p}, G_{FD,p}), spatial beam sub-selection and FD component sub-selection may also be supported and the triplet (G_{s,p}, G_{FD,p}, G_{TD/DD,p}) denotes the spatial beam sub-selection, FD component sub-selection and TD/DD component sub-selection.

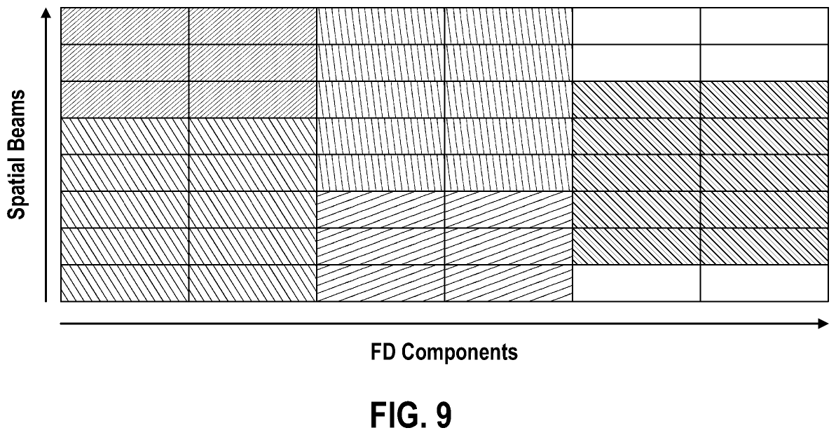

FIG. 9 illustrates a decomposition of the spatial-domain and frequency-domain space into non-orthogonal groups of spatial beams and FD components for independent selection of TD or DD basis vectors for different groups of SD and FD basis vectors, according to one aspect of the disclosure. The groups of spatial beams and FD components are non-orthogonal because a selected spatial beam does not extend across all the FD components and a selected FD component does not extend across all the spatial beams. FIG. 9 shows 5 rectangular groups of pairing of SD basis vectors and FD basis vectors in which each group comprises contiguous selections of spatial beams and FD components.

In one aspect, for full flexibility, each grid on the spatial beam/FD component grid may be given an index for the group membership. Each group is not constrained by taking the shape of contiguous or distributed rectangle. If a grid is marked by a special symbol, say zero, then no TD/DD basis sub-selection is needed (for zero linear combination coefficients). For sub-selection, a number of alternatives may be considered: a bitmap or combinatorial indexing to select a certain number of elements out of M_{d}·M×1 a vector can be used to select TD/FD component pairs; a bitmap or combinatorial indexing to select a certain number of elements out of M_{d}·2L×1 a vector can be used to select SD/TD component pairs; a bitmap or combinatorial indexing to select a certain number of elements out of 2L·M×1 a vector can be used to select SD/FD component pairs; a bitmap or combinatorial indexing to select a certain number of elements out of 2L·M_{d}·M×1 a vector can be used to select SD/FD/TD component triplets.

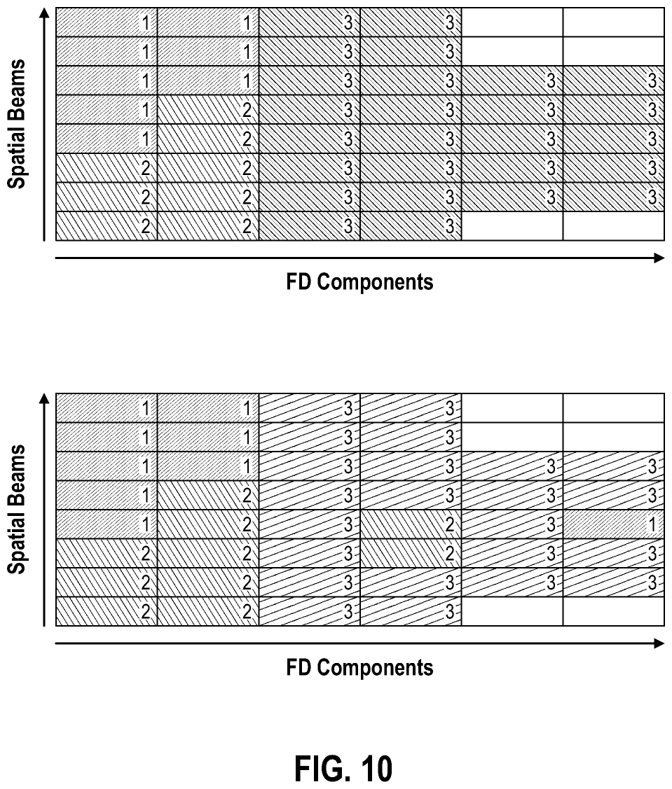

FIG. 10 illustrates a decomposition of the spatial-domain and frequency-domain space into non-orthogonal groups of spatial beams and FD components for independent selection of TD or DD basis vectors for different groups of SD and FD basis vectors where each group may contain non-rectangular or non-contiguous selection of the spatial beams and FD components, according to one aspect of the disclosure. The top grid of FIG. 10 shows 3 groups of pairing of SD basis vectors and FD basis vectors in which each group comprises contiguous selections of spatial beams and FD components, but the selections within a group may be non-rectangular. The bottom grid of FIG. 10 also shows 3 groups of pairing of SD basis vectors and FD basis vectors, but the selections of spatial beams and FD components within a group may be non-contiguous and non-rectangular.

When restriction is imposed on the sub-selection, for example the selected spatial beams for different groups are required to be non-overlapping, and/or the selected FD components for different groups are required to be non-overlapping, signaling overhead for indicating sub selection can be reduced, which can be understood by an example in the sub-selection in the spatial beams. Let the first group be associated with L_1 spatial beams out of 2L spatial beams, and the second group be associated with L_2 spatial beams out of 2L spatial beams, then a bitmap of length 2L can be used for indicating the sub-selection of the first group. After that, since L_1 spatial beams are already taken, then L_2 spatial beams need to be selected from the remaining 2L minus L_1 spatial beams, and a bitmap of length 2L-L_1 can be used for the second group, and so on. If a combinatorial indexing is used to select L_1 out of 2L spatial beams for the first group, then a combinatorial indexing can be used to select L_2 out of (2L-L_1) spatial beams. Similarly for FD component sub-selection, similar designs can be used. Further the ordering of groups can be according to the number of selected spatial beams in a group, the number of selected FD components in a group, or product of the number of selected spatial beams in a group and the number of selected FD components in the same group, in descending order or ascending order. And mixed use of bitmap and combinatorial indexing can be used. In one example, for the first group, sub-selection through bitmap is used, and for a later group combinatorial indexing is used. As the sub-selection signaling overhead may not be a constant, for example with the bitmap based signaling for two groups, and assume in one case L=4, L_1=2, L_2=2, then the sum of the length of the first bitmap and length of second bitmap is 2L+(2L−L_1)=8+6=14; for another case L=4, L_1=3, L_2=1, then the sum of the length of the first bitmap and length of second bitmap is 2L+(2L−L_1)=8+5=13. The signaling overhead for sub-selection(s) for spatial beams and/or FD components and/or TD components can be included in CSI report part 1 to facilitate network's parsing of the CSI feedback information. The signaling overhead can be a number indicating the number of bits used for sub-selection(s), or the difference between the number of bits used for sub-selection(s) and a reference number. In one design, the reference number is the smallest number of bits used for sub-selection(s) supported by the radio technology specification.

Each group of SD and FD basis vectors is associated with a separate TD/DD component selection. The number of supported groups (e.g., the maximum number of supported groups) may be RRC configured, and the actually indicated groups may be reported by UE. In one example, if the number of supported group is 1, with the indication of not independently selecting TD/DD basis vectors, then 2 code states are needed, and the legacy bitmap may be used. In another example, if the maximum number of reported groups is 3, then 4 code states are used for the TD/DD basis vectors sub-selection indication. If the UE happens to select only one group, then the 1-bit signaling for each grid as in the legacy design may be used, and the feedback overhead may be reduced. To facilitate that, the number of indicated groups P may be included in CSI part 1, so the network knows the size of CSI part 2.

Then the code structure for independent selection of TD basis vectors for different groups of spatial beams and FD components may be given by:

$${\sum }_{p = 1}^{P} ( {W}_{f , p}^{*} ⊗ {W}_{1 , p} ) {W}_{2 , p} {W}_{t , p}^{H}$$

Here, P is the number of groups for SD/FD sub-selection, W_{f,p} (N₃×Mₚ), W_{1,p} (Nₜₓ×2Lₚ), and W_{t,p} (N₄×M_{d,p}) are the sub-selection of FD components W_{f}, spatial beams W₁, and TD components Wₜ, respectively, and W_{2,p} is a LC coefficient matrix of appropriate dimension accordingly. The number of selected FD components in each group may be different, the number of selected TD components in each group may be different, and the number of selected spatial beams in each group may be different. In one aspect, restriction may be imposed to limit the sub-selection signaling overhead.

Similar to the consideration on W₂ and Z, as there may be zero elements in the matrix W_{2,p}, a bitmap matrix Zₚ may be introduced to indicate the position of non-zero coefficients in the matrix W_{2,p}. The signaling overhead for Zₚ may be Mₚ·(2Lₚ)·M_{d,p} bits. And the total signaling overhead for bitmap matrices for groups 1, . . . , P is

$${\sum }_{p = 1}^{P} {M}_{P} ( 2 {L}_{p} ) .$$

M_{d,p}, which may compare favorably with M·(2L)·M_{d}, the signaling overhead for matrix Z even after accounting for the signaling overhead due to sub-selection of spatial beams, FD components and TD components. For example, there may be P (P=4) different taps in the MIMO channel, and each tap is associated with a different spatial beam and a different Doppler frequency. If there are also P different spatial beams, and P different TD components, the matrix W₂ is of size P²×P, and the signaling overhead of Z used to indicate positions of non-zero elements in the LC coefficient matrix W₂ is P³.

In contrast, if sub-selections, W_{2,p}, p=1, . . . , P is of size 1×1, the overhead for the bitmap(s) to represent the nonzero linear combination coefficients can be much less than that for Z, though some signaling overhead is incurred for the sub-selection of FD components/spatial beams/TD components. For each group (in this case for each tap), ┌log₂(P)┐ bits are incurred for sub-selection in the FD components, ┌log₂(P)┐ bits for sub-selection in the TD components, and ┌log₂(P)┐ bits for sub-selection in the spatial beams. Hence the sub-selection overhead for the P groups is given by P·3·┌log₂(P)┐. Additionally considering the overhead for P bitmap matrices Zₚ, p=1, . . . , P, where Zₚ is one bit, and the total feedback overhead is given by P·3·┌log₂(P)┐+P. With P=4, the overhead to signal sub-selection and represent Zₚ is 28 bits, which compares favorably with 64 bits for Z. In one aspect, if sub-selection of spatial beams is not restricted to select the same spatial beam for both polarizations, then 2Lₚ can be replaced by Lₚ and Lₚ acquires the meaning of denoting the total number of selected spatial beams for both polarization for group p. The total feedback overhead for bitmap matrices is

$${\sum }_{p = 1}^{P} {M}_{P} \cdot ( {L}_{p} ) \cdot {M}_{d , p}$$

and W_{1,p} is of dimensions (Nₜₓ×Lₚ).

In one aspect, the sub-selection of spatial beams and FD components may be shown as being applied to the LC coefficient matrix. In one aspect,

$${W}_{2 , p} = {S}_{left , p} [ vec ( C ( : , : , 1 ) ) , vec ( C ( : , : , {M}_{d} ) ) ] {S}_{right , p} ,$$

Here, S_{left,p} selects rows of [vec(C(:, :, 1)), . . . , vec(C(:, :, M_{d}))] from a left matrix multiplication (hence the name), and S_{right,p} selects columns of [vec(C(:, :, 1)), . . . , vec(C(:, :, M_{d}))] from a right matrix multiplication (hence the name). the code structure for independent selection of TD basis vectors for different groups of spatial beams and FD components may be given by:

$${\sum }_{p = 1}^{P} ( {W}_{f , p}^{*} ⊗ {W}_{1 , p} ) {S}_{left , p} [ vec ( C ( : , : , 1 ) ) , … , vec ( C ( : , : , {M}_{d} ) ) ] {S}_{right , p} {W}_{t , p}^{H}$$

Here, P is the number of groups for SD/FD sub-selection, and W_{f,p}, W_{1,p}, and W_{t,p} are the sub-selection of FD components, spatial beams, and TD components, respectively.

In one aspect, instead of sub-selection of spatial beams and FD components, the precoder codebook construction may be formulated as a way to obtain [vec(C(:, :, 1)), . . . , vec(C(:, :, M_{d}))]. For example, when Ntx=32, L=4, N3=16, M=6, N4=8, Md=4. (32*16×8*6), the LC coefficient matrix may be W₂ ∈C^{2LM×M}^{_{d}}. LC coefficient matrix W₂ may then have 48 rows (8*6) representing the product of the number of spatial beams and the number of FD component, and 4 columns representing the number of TD components.

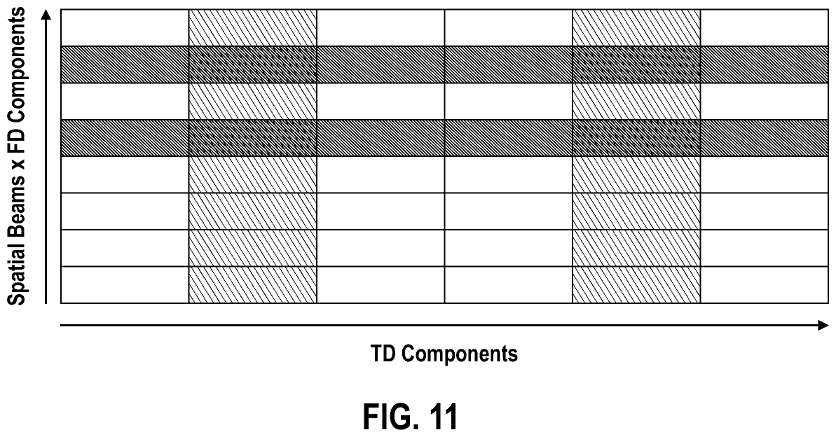

FIG. 11 illustrates a selection of TD components for different orthogonal groups of SD and FD basis vectors represented by a two-dimensional LC coefficient matrix grid, where one dimension of the grid may represent a product of the number of spatial beams and the number of FD components, and the other dimension may represent the number of TD components, according to one aspect of the disclosure. FIG. 11 shows two orthogonal groups of SD and FD basis vectors on the two-dimensional LC coefficient matrix grid.

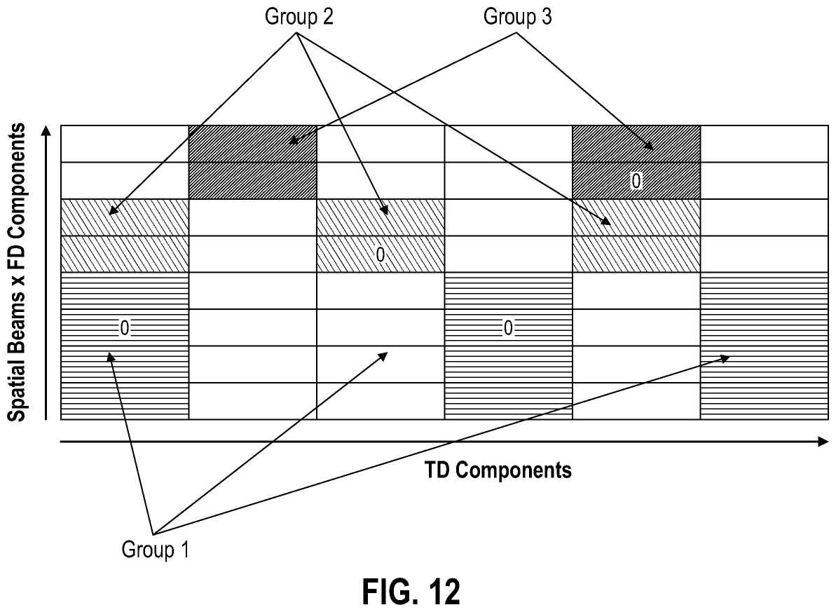

FIG. 12 illustrates a selection of TD components for different non-orthogonal groups of SD and FD basis vectors represented by a two-dimensional LC coefficient matrix grid, where one dimension of the grid may represent a product of the number of spatial beams and the number of FD components, and the other dimension may represent the number of TD components, according to one aspect of the disclosure. FIG. 12 shows three non-orthogonal groups of SD and FD basis vectors on the two-dimensional LC coefficient matrix grid and the locations where the coefficients are zero.

For each group, the signaling of selected spatial beam/FD component pair or pairs is indicated, and the signaling of selected TD components for that group is indicated.

In one aspect, a bitmap of the LC coefficient matrix and combinatorial indexing may be considered for both orthogonal groups and non-orthogonal groups of SD and FD basis vectors. In one aspect, as the product of spatial beam number (2L) and the FD component number (M) can be large, restriction may be applied so all the spatial beams for a FD component or all the FD components for a given spatial beam are selected to reduce signaling overhead.

An equivalent formulation of the precoding matrices W may be obtained by applying the expansion in the FD and TD first:

$$\begin{matrix}{W}_{f}^{*} C ( s , : , : ) {W}_{t}^{H} , \\ s = 1 , … , 2 L\end{matrix}$$

Applying the vectorization reformulation, then

$$\begin{matrix}vec ( {W}_{f}^{*} C ( s , : , : ) {W}_{t}^{H} ) = ( {W}_{t}^{*} ⊗ {W}_{f}^{*} ) vec ( C ( s , : , : ) ) , \\ s = 1 , … , 2 L .\end{matrix}$$

A row vector may be built as the transpose of vec(W_{f}*C(s, :,)Wₜ^{H}), and stack all the row vectors, then

$$\begin{matrix}[ \begin{matrix}{( vec ( {W}_{f}^{*} C ( 1 , : , : ) {W}_{t}^{H} ) )}^{T} \\ ⋮ \\ {( vec ( {W}_{f}^{*} C ( 2 L , : , : ) {W}_{t}^{H} ) )}^{T}\end{matrix} ] = [ \begin{matrix}{vec ( C ( 1 , : , : ) )}^{T} \\ ⋮ \\ {vec ( C ( 2 L , : , : ) )}^{T}\end{matrix} ] {( {W}_{t}^{*} ⊗ {W}_{f}^{*} )}^{T} \\ = [ \begin{matrix}{vec ( C ( 1 , : , : ) )}^{T} \\ ⋮ \\ {vec ( C ( 2 L , : , : ) )}^{T}\end{matrix} ] {( {W}_{t} ⊗ {W}_{f} )}^{H}\end{matrix}$$

Wₜ ⊗W_{f} is M·M_{d} ⊗N₃·N₄. Expanding on the spatial domain, and N₃·N₄ precoders are given by:

$${W}_{1} [ \begin{matrix}vec {( C ( 1 , : , : ) )}^{T} \\ ⋮ \\ vec {( C ( 2 L , : , : ) )}^{T}\end{matrix} ] {( {W}_{t} ⊗ {W}_{f} )}^{H}$$

An equivalent formulation of the precoding matrices W obtained by applying the expansion in the FD and TD first may be derived. Let the multiple dimensional coefficient matrix be C(i,j, k), 1≤i≤2L, 1≤j≤M_{d}, 1≤k≤M. Note the indexing scheme is different from that for the rest of formulations.

Applying the expansion in the TD and FD first:

$$\begin{matrix}{W}_{t}^{*} C ( s , : , : ) {W}_{f}^{H} , \\ s = 1 , … , 2 L\end{matrix}$$

Applying the vectorization reformulation, then

$$\begin{matrix}vec ( {W}_{t}^{*} C ( s , : , : ) {W}_{f}^{H} ) = ( {W}_{f}^{*} ⊗ {W}_{t}^{*} ) vec ( C ( s , : , : ) ) , \\ s = 1 , … , 2 L .\end{matrix}$$

A row vector may be built as the transpose of vec(W_{f}*C(s, : ,)Wₜ^{H}), and stack all the row vectors, then

$$\begin{matrix}[ \begin{matrix}{( vec ( {W}_{t}^{*} C ( 1 , : , : ) {W}_{f}^{H} ) )}^{T} \\ ⋮ \\ {( vec ( {W}_{t}^{*} C ( 2 L , : , : ) {W}_{f}^{H} ) )}^{T}\end{matrix} ] = [ \begin{matrix}{vec ( C ( 1 , : , : ) )}^{T} \\ ⋮ \\ {vec ( C ( 2 L , : , : ) )}^{T}\end{matrix} ] {( {W}_{f}^{*} ⊗ {W}_{t}^{*} )}^{T} \\ = [ \begin{matrix}{vec ( C ( 1 , : , : ) )}^{T} \\ ⋮ \\ {vec ( C ( 2 L , : , : ) )}^{T}\end{matrix} ] {( {W}_{f} ⊗ {W}_{t} )}^{H}\end{matrix}$$

W_{f} ⊗Wₜ is M_{d}·M⊗N₄⊗N₃. Expanding on the spatial domain, so N₄ ⊗N₃ precoders are given by:

$${W}_{1} [ \begin{matrix}{vec ( C ( 1 , : , : ) )}^{T} \\ ⋮ \\ {vec ( C ( 2 L , : , : ) )}^{T}\end{matrix} ] {( {W}_{f} ⊗ {W}_{t} )}^{H}$$

In one aspect, the code structure for independent selection of DD basis vectors for different groups of spatial beams and FD components may be given by:

$$\begin{matrix}{\sum }_{p = 1}^{P} {W}_{1 , p} [ \begin{matrix}vec {( C ( 1 , : , : ) )}^{T} \\ ⋮ \\ vec {( C ( 2 {L}_{,} : , : ) )}^{T}\end{matrix} ] {( {W}_{f , p} ⊗ {W}_{t , p} )}^{H} or \\ {\sum }_{p = 1}^{P} {W}_{1 , p} {{\tilde{W}}_{2 , p} ( {W}_{f , p} ⊗ {W}_{t , p} )}^{H}\end{matrix}$$

Here, P is the number of groups for SD/FD sub-selection, W_{f,p}(N₃×Mₚ), W_{1,p} (Nₜₓ×2Lₚ), and W_{t,p}(N₄×M_{d,p}) are the sub-selection of FD components, spatial beams, and TD components, respectively, and \tilde{W}_{2,p} is a LC coefficient matrix of appropriate dimension accordingly. The precoder codebook construction may be formulated as a way to obtain [vec(C(1, :, :)), . . . , vec(C(2L, :, :))]. LC coefficient matrix \tilde{W}_{2,p} may then have a number of rows representing the number of spatial beams, and a number of columns representing the product of the number of FD component and the number of TD components.

Similar to the consideration on W₂ and Z, and W_{2,p} and Zₚ, as there may be zero elements in the matrix \tilde{W}_{2,p}, a bitmap matrix \tilde{Z}ₚ may be introduced to indicate the position of non-zero coefficients in the matrix \tilde{W}_{2,p}. The signaling overhead for \tilde{Z}ₚ is Mₚ·(2Lₚ)·M_{d,p} bits. The total signaling overhead for bitmap matrices for groups 1, . . . , P is

$${\sum }_{p = 1}^{P} {M}_{p} ( 2 {L}_{p} ) .$$

M_{d,p}, which may compare favorably with M·(2L)·M_{d}, the signaling overhead for matrix Z even after accounting for the signaling overhead due to sub-selection of spatial beams, FD components and TD components. If sub-selection of spatial beams is not restricted to select the same spatial beam for both polarizations, then 2Lₚ can be replaced by Lₚ, and Lₚ acquires the meaning of denoting the total number of selected spatial beams for both polarization for group p. The total feedback overhead for bitmap matrices is

$${\sum }_{p = 1}^{P} {M}_{P} \cdot ( {L}_{p} ) \cdot {M}_{d , p}$$

and W_{1,p} is of dimensions (Nₜₓ×Lₚ). For sub-selection, a number of alternatives may be considered: a bitmap or combinatorial indexing to select a certain number of elements out of M_{d}·M×1 a vector can be used to select TD/FD component pairs; a bitmap or combinatorial indexing to select a certain number of elements out of M_{d}·2L×1 a vector can be used to select SD/TD component pairs; a bitmap or combinatorial indexing to select a certain number of elements out of 2L·M×1 a vector can be used to select SD/FD component pairs; a bitmap or combinatorial indexing to select a certain number of elements out of 2L·M_{d}·M×1 a vector can be used to select SD/FD/TD component triplets.

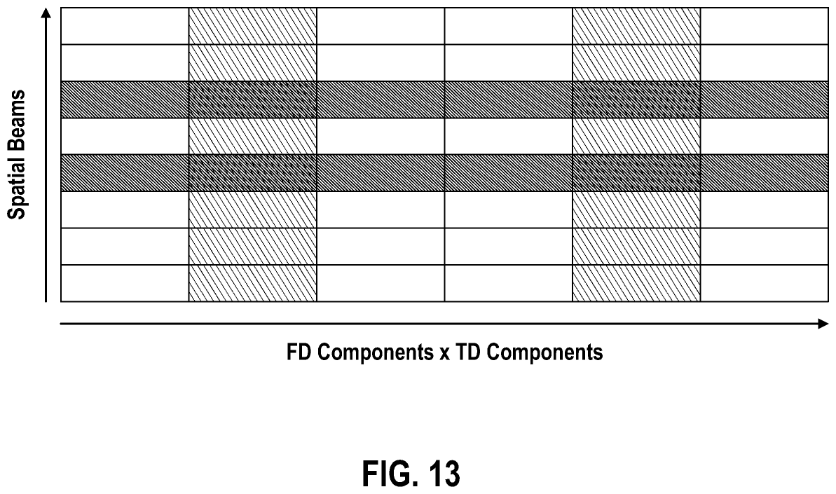

FIG. 13 illustrates a selection of TD components for different orthogonal groups of SD and FD basis vectors represented by a two-dimensional grid, where one dimension of the grid may represent a product of the number of FD components and the number of TD components, and the other dimension may represent the number of spatial beams, according to one aspect of the disclosure. FIG. 13 shows two orthogonal groups of SD and FD basis vectors on the two-dimensional LC coefficient matrix grid.

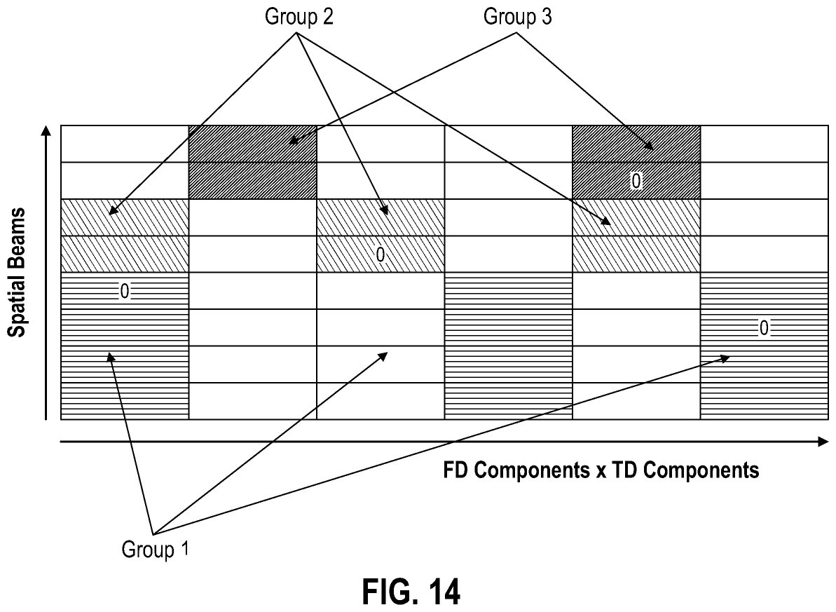

FIG. 14 illustrates a selection of TD components for different non-orthogonal groups of SD and FD basis vectors represented by a two-dimensional grid, where one dimension of the grid may represent a product of the number of FD components and the number of TD components, and the other dimension may represent the number of spatial beams, according to one aspect of the disclosure. FIG. 14 shows three non-orthogonal groups of SD and FD basis vectors on the two-dimensional LC coefficient matrix grid and the locations where the coefficients are zero.

For each group, the signaling of FD components/TD component pair(s) is indicated, and signaling of selected spatial beams for that group is indicated.

In one aspect, a bitmap of the LC coefficient matrix and combinatorial indexing may be considered for both orthogonal groups and non-orthogonal groups of SD and FD basis vectors. In one aspect, as the product of FD component number (M) and the TD component number (Md) can be large, restriction may be applied so all the TD components for a FD component or all the FD components for a given TD component are selected to reduce signaling overhead.

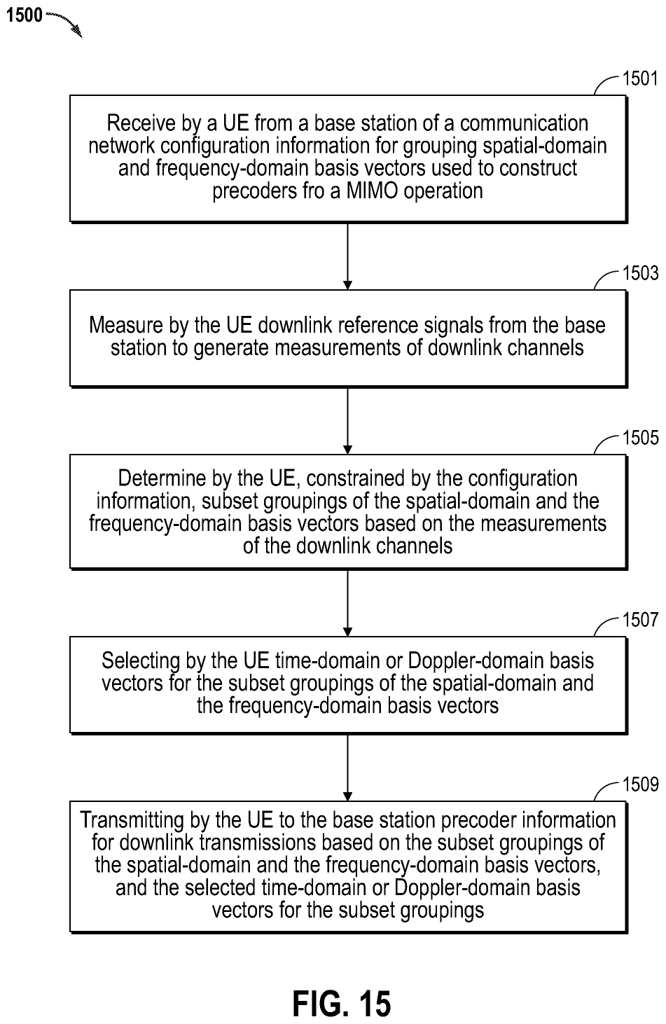

FIG. 15 depicts a flow diagram of a method for a UE to independently select TD or DD basis vectors for different groupings of SD and FD basis vectors and to report the sub-selection of the spatial beams, the sub-selection of FD components, the sub-selection of TD/DD components for each group according to one aspect of the disclosure. The method may be practiced by the UE of FIG. 1, 2, 3, or 5.

In operation 1501, the UE receives from a base station of a communication network configuration information for grouping SD and FD basis vectors used to construct precoders for MIMO operations. The configuration information may indicate a maximum number of supported groups of the spatial beams and FD components.

In operation 1503, the UE measures downlink reference signals transmitted by the base station to generate measurements of downlink channels. In one aspect, the downlink reference signals may be channel state information reference signals (CSI-RS).

In operation 1505, the UE determines, constrained by the configuration information, subset groupings of the SD basis vectors (spatial beams) and the FD basis vectors based on the measurements of the downlink channels.

In operation 1507, the UE selects TD or DD basis vectors for the subset groupings of the SD and FD basis vectors.

In operation 1509, the UE transmits to the base station precoder information for downlink transmission based on the subset groupings of the SD and FD basis vectors, and the selected TD or DD basis vectors for the subset groupings.

In one aspect, the described operations to enhance the reporting of precoding matrix information associated with fast changing channel response by independently selecting TD or DD basis vectors for different groupings of SD and FD basis vectors may be practiced by a UE that includes at least one antenna, at least one radio, and at least one processor. The radio may be configured to communicate with a communication network (e.g., a base station) through the antenna to receive downlink reference signals and data packets. The processor may be coupled to the radio and configured to perform the described operations.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to communicate with a communication network (e.g., a base station) to enhance the reporting of precoding matrix information associated with fast changing channel response by independently selecting TD or DD basis vectors for different groupings of SD and FD basis vectors.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A baseband processor of a wireless user equipment (UE) of a communication network comprising:
receiving from a base station of the communication network configuration information for grouping spatial-domain and frequency-domain basis vectors used to construct precoders of a multiple-input multiple-output (MIMO) operation;
measuring downlink reference signals from the base station to generate measurements of downlink channels;
determining, constrained by the configuration information, subset groupings of the spatial-domain and the frequency-domain basis vectors based on the measurements of downlink channels;
selecting time-domain or Doppler-domain basis vectors for the subset groupings of the spatial-domain and the frequency-domain basis vectors; and
transmitting to the base station precoder information for downlink transmissions based on the subset groupings of the spatial-domain and the frequency-domain basis vectors, and the selected time-domain or Doppler-domain basis vectors for the subset groupings.

2. The baseband processor of claim 1, wherein the configuration information comprises a maximum number of the subset groupings of the spatial-domain and the frequency-domain basis vectors.

3. The baseband processor of claim 1, wherein the subset groupings of the spatial-domain and the frequency-domain basis vectors comprise a sub-selection of spatial beams and a sub-selection of frequency-domain components selected for the precoders.

4. The baseband processor of claim 3, wherein the subset groupings of the spatial-domain and the frequency-domain basis vectors comprise an orthogonal decomposition of a two-dimensional grid of spatial and frequency domains, wherein the sub-selection of the spatial beams extends across all the frequency-domain components and the sub-selection of the frequency-domain components extend across all the spatial beams.

5. The baseband processor of claim 3, wherein selecting the time-domain or Doppler-domain basis vectors for the subset groupings of the spatial-domain and the frequency-domain basis vectors comprises ignoring inactive spatial beams or inactive frequency-domain components based on the measurements of the downlink channel.

6. The baseband processor of claim 3, wherein each of the subset groupings of the spatial-domain and the frequency-domain basis vectors comprises a contiguous selection of the spatial beams and the frequency-domain components.

7. The baseband processor of claim 3, wherein one of the subset groupings of the spatial-domain and the frequency-domain basis vectors comprises a non-contiguous selection of the spatial beams and the frequency-domain components.

8. The baseband processor of claim 3, wherein the subset groupings of the spatial-domain and the frequency-domain basis vectors comprise a non-orthogonal decomposition of a two-dimensional grid of spatial and frequency domains, wherein the sub-selection of the spatial beams fails to extend across all the frequency-domain components, or the sub-selection of the frequency-domain components fails to extend across all the spatial beams.

9. The baseband processor of claim 1, wherein the subset groupings of the spatial-domain and the frequency-domain basis vectors comprise a sub-selection of rows and columns of a coefficient matrix.

10. The baseband processor of claim 9, wherein selecting the time-domain basis vectors for the subset groupings of the spatial-domain and the frequency-domain basis vectors comprises selecting groupings of elements of the coefficient matrix that have non-zero values.

11. The baseband processor of claim 9, wherein the coefficient matrix has a number of rows determined by a product of a number of the spatial-domain basis vectors and a number of the frequency-domain basis vectors, and a number of columns determined by a number of the time-domain basis vectors.

12. The baseband processor of claim 9, wherein the sub-selection of the rows extends across all the columns of the coefficient matrix extend and the sub-selection of the columns extends across all the rows of the coefficient matrix.

13. The baseband processor of claim 9, wherein the sub-selection of the rows fails to extend across all the columns of the coefficient matrix extend or the sub-selection of the columns fails to extend across all the rows of the coefficient matrix.

14. The baseband processor of claim 11, wherein transmitting to the base station precoder information comprises indicating selected pairs of the spatial-domain basis vectors and the frequency-domain basis vectors for each of the subset grouping, indicating selected time-domain basis vectors for each of the subset grouping, and indicating the coefficient matrix for each of the subset grouping.

15. The baseband processor of claim 11, wherein transmitting to the base station information on the independently selected time-domain basis vectors for the subset groupings comprises indicating elements of the coefficient matrix with zero values.

16. The baseband processor of claim 1, wherein the subset groupings of the spatial-domain and the frequency-domain basis vectors comprise a sub-selection of rows and columns of a coefficient matrix for the spatial-domain basis vectors.

17. The baseband processor of claim 16, wherein selecting the selected Doppler-domain basis vectors for the subset groupings of the spatial-domain and the frequency-domain basis vectors comprises selecting groupings of elements of the coefficient matrix that have non-zero values.

18. The baseband processor of claim 16, wherein the coefficient matrix has a number of rows determined by a number of the spatial-domain basis vectors and a number of columns determined by a product of a number of the frequency-domain basis vectors and a number of the Doppler-domain basis vectors.

19-22. (canceled)

23. A wireless device of a communication network, comprising:
at least one antenna;
at least one radio, wherein the at least one radio is configured to communicate with the communication network using the at least one antenna; and
at least one processor coupled to the at least one radio, wherein the at least one processor is configured to perform operations comprising:
receive from the communication network configuration information for grouping spatial-domain and frequency-domain basis vectors used to construct precoders of a multiple-input multiple-output (MIMO) operation;
measure downlink reference signals from the base station to generate measurements of downlink channels;
determining, constrained by the configuration information, subset groupings of the spatial-domain and the frequency-domain basis vectors based on the measurements of downlink channels;
select time-domain or Doppler-domain basis vectors for the subset groupings of the spatial-domain and the frequency-domain basis vectors; and
transmit to the communication network precoder information for downlink transmissions based on the subset groupings of the spatial-domain and the frequency-domain basis vectors, and the selected time-domain or Doppler-domain basis vectors for the subset groupings.

24. A method, performed by a user equipment (UE), the method comprising:
receiving from a base station of the communication network configuration information for grouping spatial-domain and frequency-domain basis vectors used to construct precoders of a multiple-input multiple-output (MIMO) operation;
measuring downlink reference signals from the base station to generate measurements of downlink channels;
determining, constrained by the configuration information, subset groupings of the spatial-domain and the frequency-domain basis vectors based on the measurements of downlink channels;
selecting time-domain or Doppler-domain basis vectors for the subset groupings of the spatial-domain and the frequency-domain basis vectors; and
transmitting to the base station precoder information for downlink transmissions based on the subset groupings of the spatial-domain and the frequency-domain basis vectors, and the selected time-domain or Doppler-domain basis vectors for the subset groupings.
